(19) United States
(12) Patent Application Publication
(10) Pub. No.: US 2008/0071794 A1
(43) Pub. Date: Mar. 20, 2008

(54) VIRTUAL PERSONAL TRAINER

(76) Inventor: Gerard Johannes Barnard, Johannesburg, CA (US)

Correspondence Address: HAHN AND MOODLEY, LLP, P.O. BOX 52050, MINNEAPOLIS, MN, 55402, US

(21) Appl. No.: 11/756,488

(22) Filed: May 31, 2007

(30) Foreign Application Priority Data
May 31, 2006 (ZA) ZA 2006/4416
May 31, 2006 (ZA) ZAP 2006/4466

(51) Int. Cl. G06F 17/30

(52) U.S. Cl. 707/10; 707/E17.032

(57) ABSTRACT

Apparatus and method are provided that allows a person using a gym or playing a sport to interact via a cell phone with an internet database via communication protocols to access a training program, update same, measure progress to defined goals, receive news of sporting and other events and receive motivational and training input.

This application claims the benefit of priority to South African Provisional Applications ZA 2006/4416 and ZAP 2006/4466 both of which were filed on 31 May 2006.

### FIELD

This invention lies in the field of physical training and sport training and exercising. For example, the invention can be used to generate customised training programmes and diet plans for use in muscle building, fitness development, sports training such as in cycling, jogging, marathon and other running, golf, tennis, weight loss programs and many other physical activities that may benefit from programmed activities or quantified/quantifiable feedback or information.

### BACKGROUND

Training and exercising in order to develop physically and enhance performance in physical activities, is offered in gymnasiums and in sporting grounds run by clubs, schools and other institutions, where the individual either practices and trains individually or under training by an instructor or coach. Training alone has generally speaking a low rate of achievement as the individual must move into what is uncharted territory for him or her (regarding information on nutrition, training techniques, fitness tips as well as general health and safety information). Accurate, up-to-date information on training, fitness, nutrition and health/safety is only one part of the problem; the other is usually: one training program or diet plan is not a one-size-fits-ail solution. These two have to be designed with age, weight, health, gender, height and other variables (such as body type) in mind—in the foreseeable future genetic typing may be useful as weil to accurately match a specific individual's biological requirements. Creating these manually is time consuming, requires the expertise of a personal trainer or other fitness professional at the very least. To compound the problem there is no way of getting feedback, having designed a customised programme. Having a personal trainer is expensive, alternatively being trained or taught in a group loses the personal touch where the individual requirements are not specifically catered for. A suitable application of modern technology offers the opportunity of alleviating these shortcomings in one go.

### SUMMARY

Apparatus in accordance with this invention includes a central processing unit or computer which is programmed with the facility to store data, communicate through the internet to a mobile phone network and thence to mobile phones and/or mobile devices and personal computers (PC's), the data including measurable physical characteristics, performance characteristics, nutritional and other information of individuals stored as historial data and as vanable goal setting options, programs for development and improvement of these characteristics, linked to gymnasium and sporting facility environments, access codes and routing protocols for messaging to and from a cell phone and/or mobile device and for transfer of data, date and time interface functionality and optionally diary and event data.

The invention is thus an internet or web-to-mobile/cell phone/mobile device system that enables members to access and to update data relating to sport or other physical activity and fitness details from their mobile phone or cell phone and/or mobile device with the web site. The communication between these is two-way: the data that is sent to the database is converted into feedback that is displayed in graphic form for the user. The information used by the member can be displayed either on a cell phone or on a PC browser.

The invention also provides a method of physical training in a sport or in bodily development or fitness: which comprises the steps of registering personal particulars and goals on a database, receiving a training program designed to achieve the goals, carrying out the program and monitoring development towards the goal; the method allows modifying the program as the person progresses. This feedback has the effect of motivating the user to stick to the training routine as a consequence of measurable: quantifiable results. The system therefore makes visible the inputs as well as the outputs of the user thereby enhancing the training experience.

The member is able to access training and nutritional information on demand from a cell phone wherever there is the ability to connect, for example in a gym while actively engaged with exercises etc. The member is able to forward information from the locality where he or she is to the central database and software is adapted to generate a report that may include graphical representation of progress of the individual towards a goal, which may be set by the individual and/or suggested by the system. Competitive aspects may be handled by the system as well, for example the comparative progress or position relative to other members that are using the system.

The database may also contain and be regularly updated by a system operator with information about sporting and other events and a program be operated to send out notices (alerts) to members about upcoming events, giving dates, times and locales. A ‘message box’ function can be implemented if desired. The data may include historical (including very recent) information about major competitive events, sent out as news items to members cell phones. Features about players in professional sports, matches etc may be included.

The transfer of data need not be via SMS/MMS, but may use the cheaper data packets transmissions.

The invention may utilize wireless application protocol (WAR), which may include 3G, GPRS, HSDPC and future possible communication layers, short messaging service (SMS) and multi media service (MMS) technologies, so that the programmes may not be downloadable applications, but browser-based communications and dynamic data transfers may be used rather than SMS messages. This allows two-way continuous communication to and from a fitness gym or other locale about sporting events.

This allows the user to view and update information relating to sporting events directly from their mobile phone/mobile device to a database, from which it is accessible.

A registration screen via internet or cell phone/mobile device allows registration and recording of personal details and a computer program can provide a program of exercise and/or activity to lead the person to achieving specified goals.

### BRIEF DESCRIPTION OF THE DRAWINGS

The invention is more fully described by way of examples, with reference to the drawings, in which:—

FIG. 1 is a schematic representation of the general concept of the invention,

FIG. 2 is a block diagram showing the functionality of the interaction with persons that the program is designed to carry into effect,

FIG. 3 is a screen used in a registration mode of the program,

FIG. 4 is a screen used in a option selection mode of the program,

FIG. 5 is a screen used in a profile summary mode of the program, and

FIG. 6 is a schematic of a preferred embodiment.

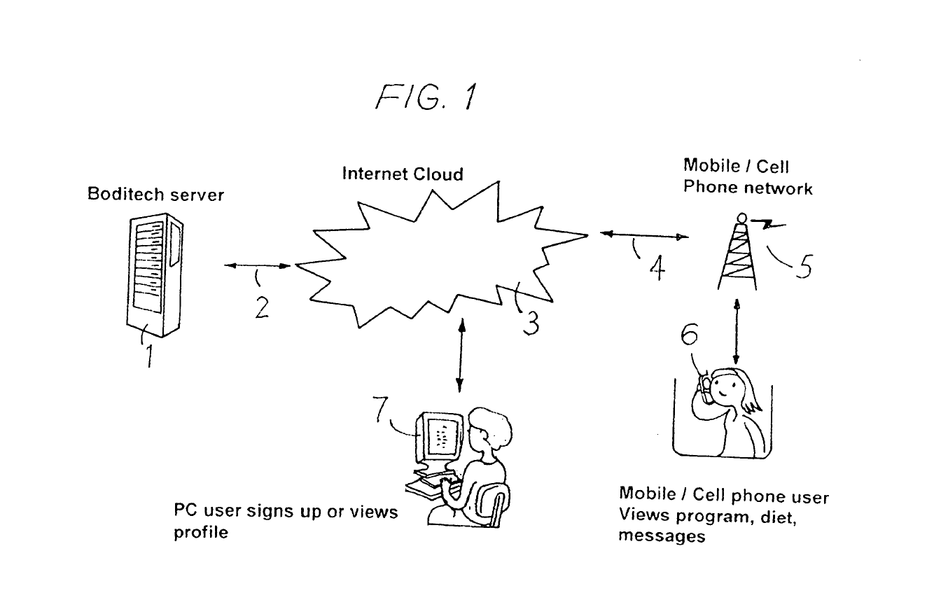

### DETAILED DESCRIPTION

As shown in FIG. 11 the overarching concept of the invention includes a central processing unit (CPU) 1, a connection means 2 for communication to and from the internet 3, a connection means 4 for communication to and from a mobile or cell phone network 5 and thence to a mobile phone 6 and also to a personal computer (PC) 7. The CPU functions as a server, which contains a database and executable programs for use in carrying out the methods of the invention.

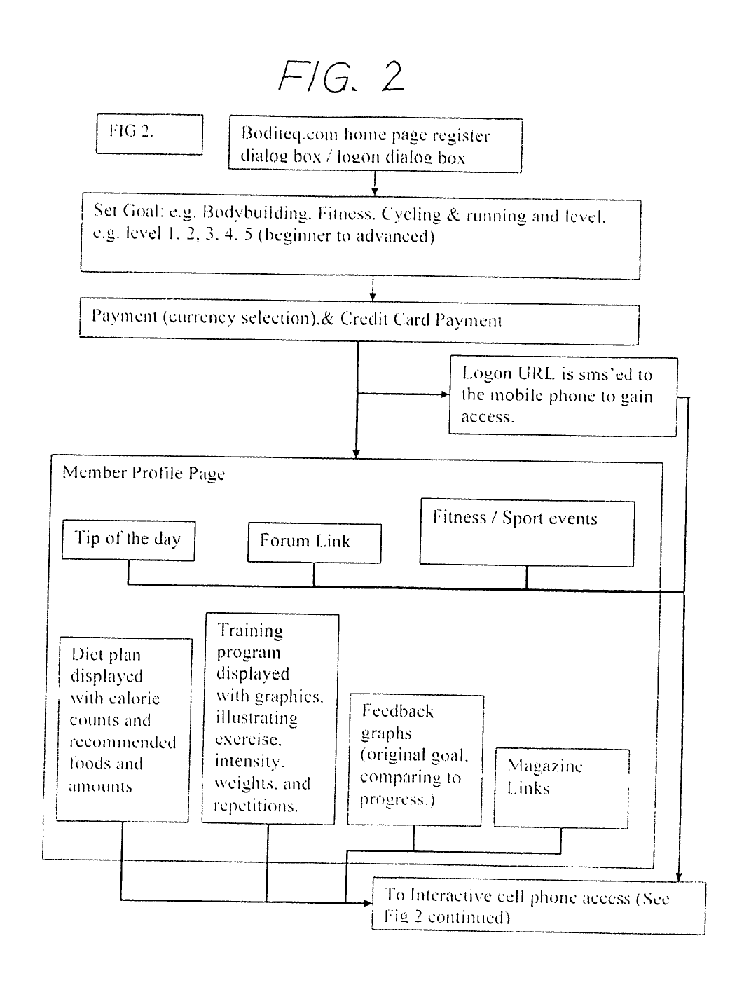

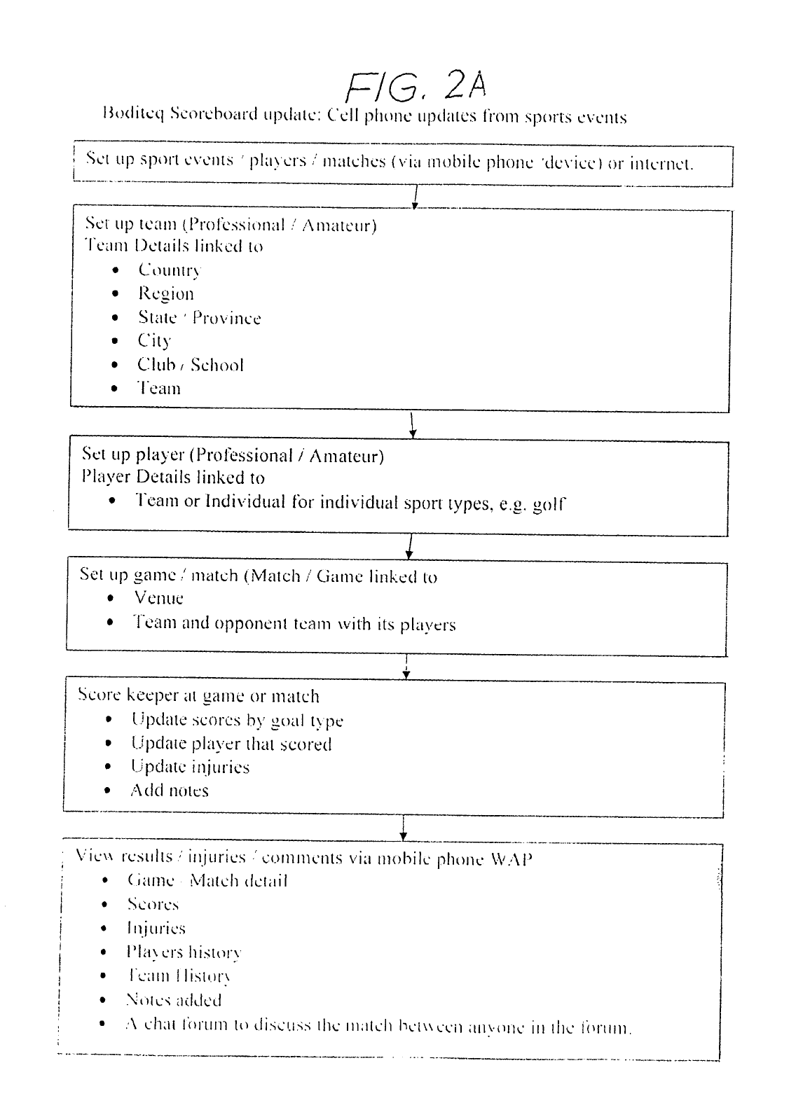

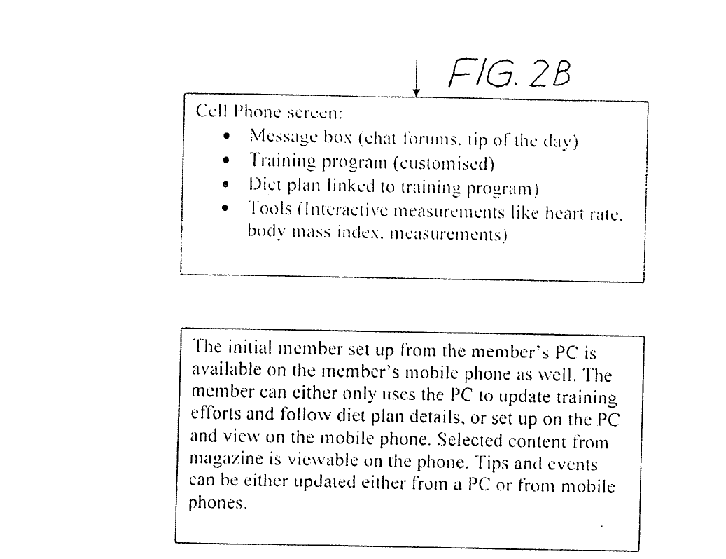

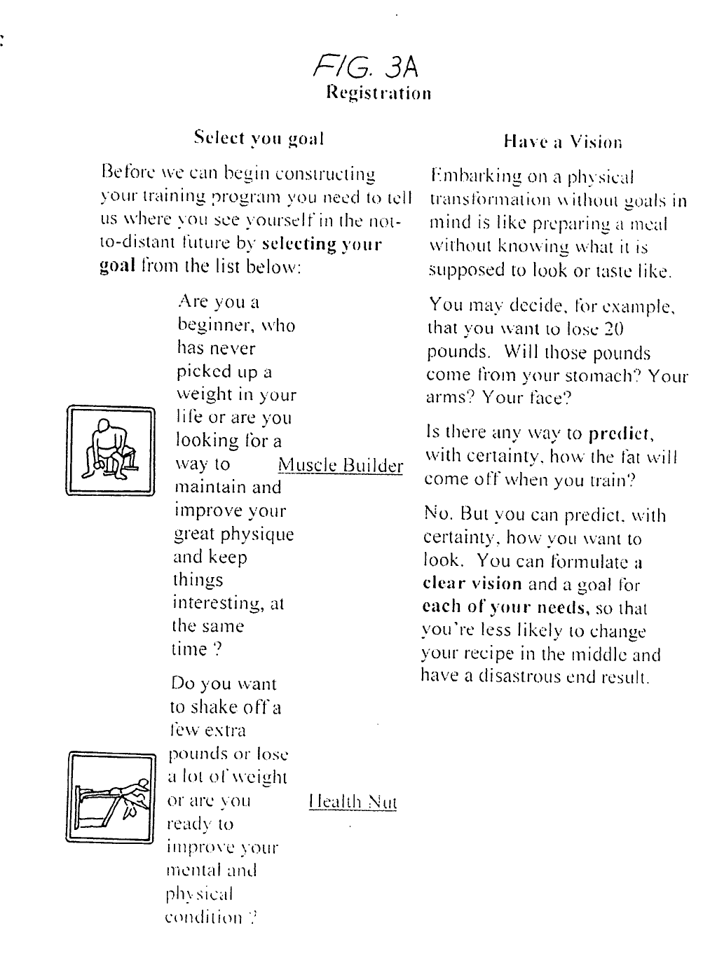

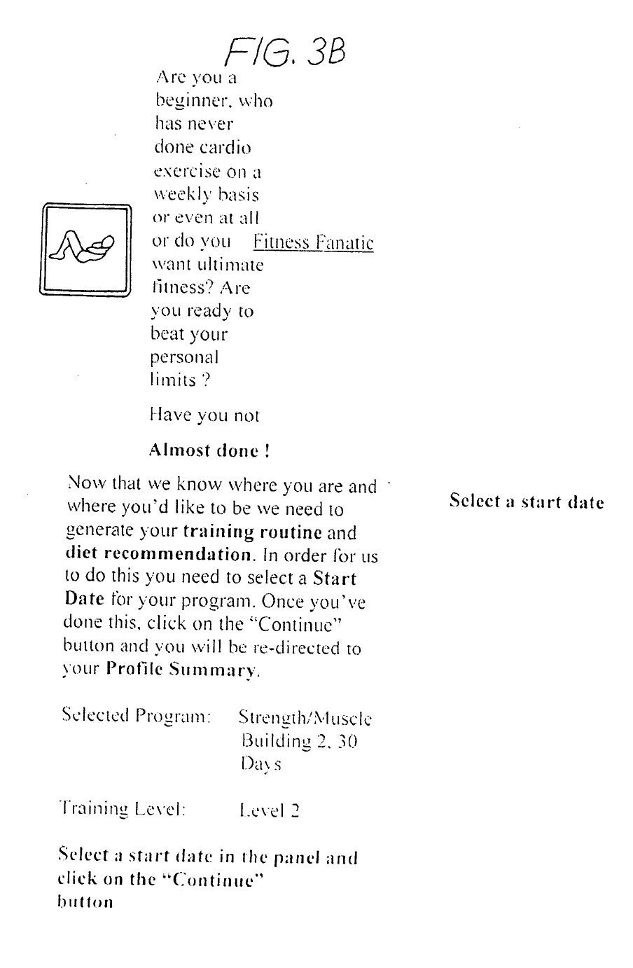

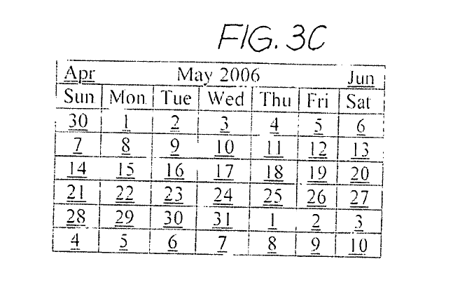

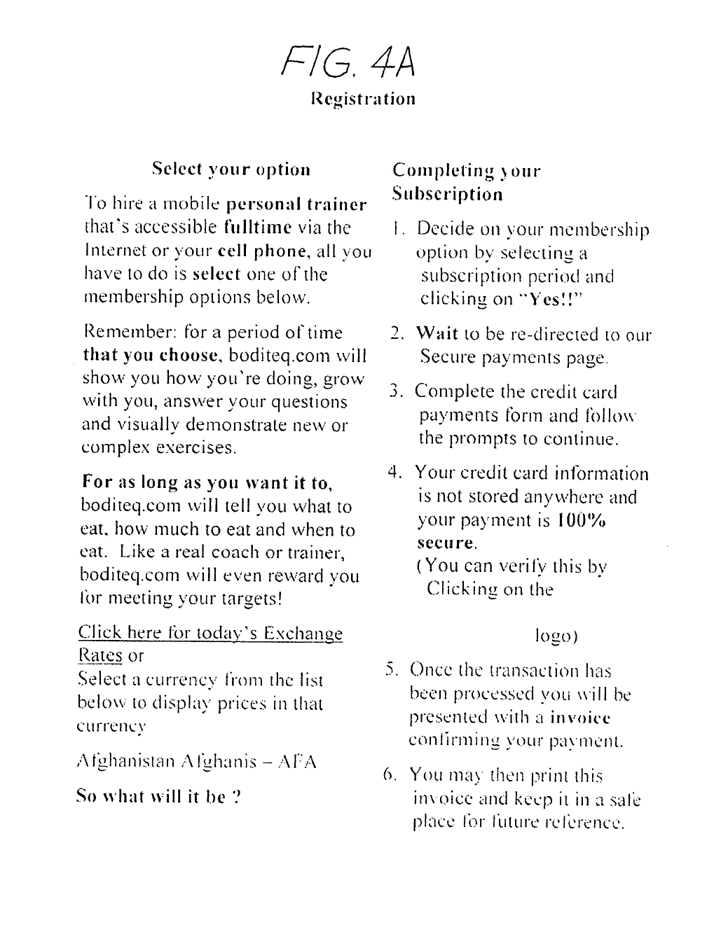

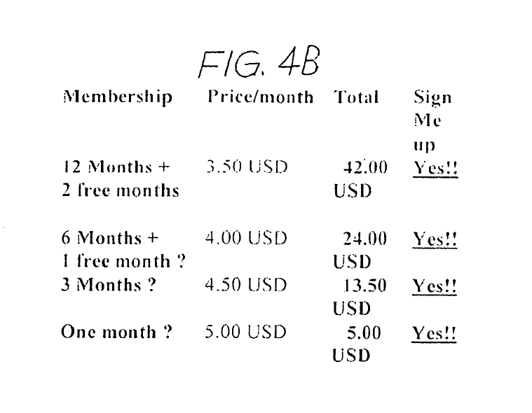

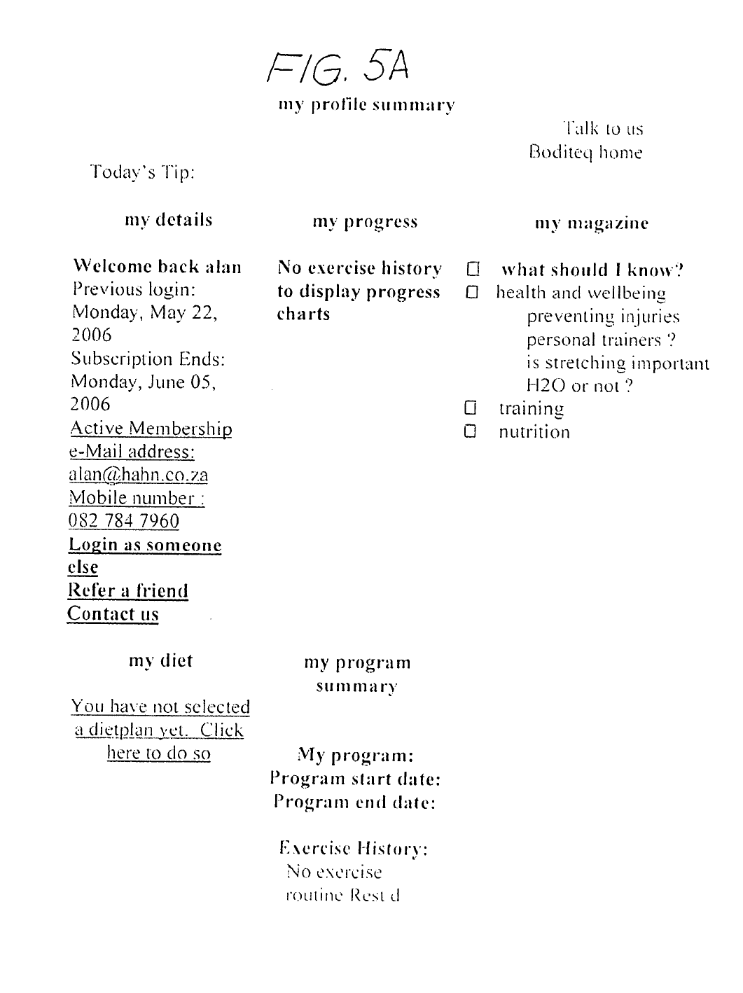

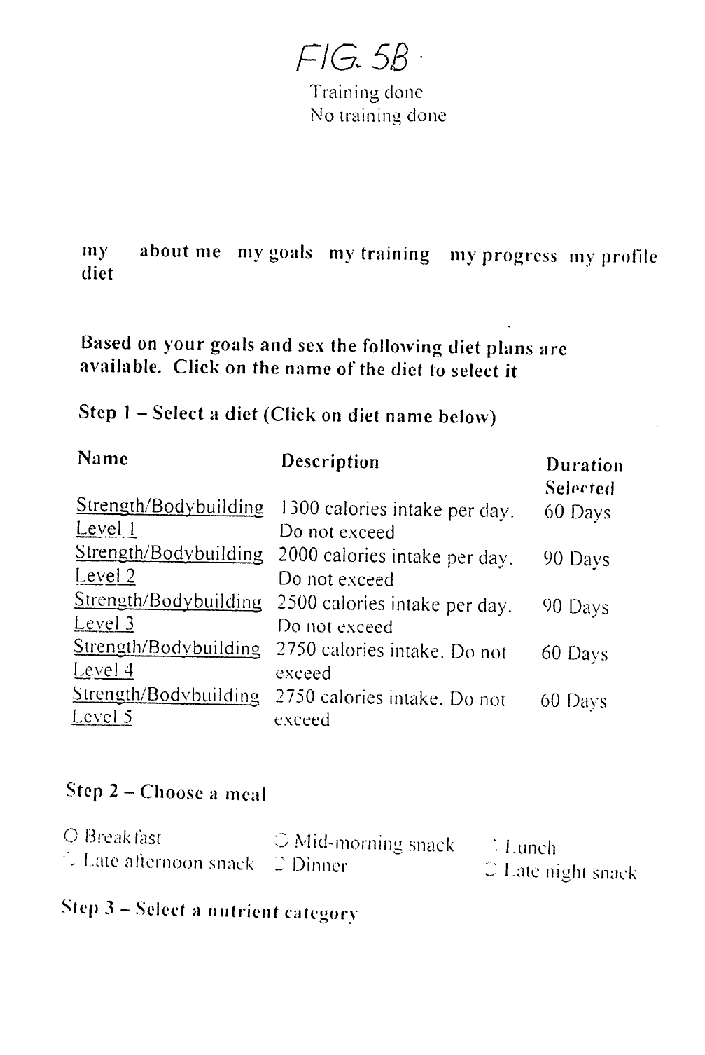

FIG. 2 shows the functional block diagram, which defines the functionality of the computer program, reference is made to it and to the text shown in each box. Registration can included e.g. age, gender, goals, mobile phone no., e-mail address, etc whereafter the system automatically designs a program for the member to satisfy their goals. The goals are any sport related goals, e.g. muscle build, general fitness, weight loss, (marathon) running, cycling, golf, etc. The system will also design a diet plan that suits the training program by giving examples of the food as well as the calorie quantities.

Once the registration process has been completed, the system sends a URL to the registered members mobile phone, which gives the member access to their individual training program directly via their mobile phone to our server. This is via mobile communication media, which currently includes GPRS, 3G, etc. The unique functionality is that the member can access their training program via their mobile phone/mobile device, update their results, and access their daily diet plan, which give them what to eat, and when to eat it.

Personal Fitness Training Program

The mobile access functionality has a menu option, where the member has the following functionality.
A message box: This allows the member to communicate directly with other members via their mobile phone with messages from one mobile, then stored on the server, and accessible to the recipient, when they sign on.
Step-by-step training program, with a description of the exercise/sporting activity, a graphical display (picture) of the activity and/or equipment, and open fields with suggested repetitions/weights, duration etc, this field will be updated by the member to indicate the results of their effort. All this is then uploaded from the cell phone/mobile device to the server, where the server feeds back a graphical display of achievement and progress. The graphical display can be accessed from the cell phone, and sent from their mobile phone to other members.
Diet plan: indicating the various meals, and the different food types (such as carbohydrates, proteins, fats etc) and the recommended/suggested quantities that the member can/should consume. The meal is displayed, with what option are available within that meal category, e.g. 2 units of protein. And then the system will indicate what options are available that will be equivalent to 2 units of protein. This is also online available on the members mobile phone/mobile device. To allow the members to keep track of their diets, they can then update the actual food eaten.
Interactive tools, such as Body Mass Index and Target Heart Rate Zone calculators. The members have the facility to view their target heart rates and capture their various phases of their heart rates, e.g. morning resting heart rate, before training heart rate, during training heart rate, after training heart rate these have safety and health implications.
General measurements input box (such as body part dimensions—chest size): where members can input general measurements on their mobile phone, e.g. chest measurement, etc to allow our system to calcalate muscle growth, comparing to training results, Body Fat index, etc.

Publishing; Sports events results updates: (Via Mobile phone, mobile device and direct internet)
Capture and update team details, which include team location, sports type, score by members of the team real time via mobile application for any type of sport event, eg. rugby, football, basketball etc.
Capture team member details, which include team member personal details, achievements history, and real time scoring update via Cell phone.
Capture and update match details, with the teams participating and the members playing in the match.
Capturing and updating of scores real time as the match progresses directly via mobile phone, using the sport type score, sportsman that scored and match details. This updates the main scoreboard on our system, and ensures updated available information for supporters anywhere worldwide to look up scores, game history, etc.
Access all of the above information from any mobile phone, mobile device world wide per country, region city club/school etc.
Supporters at the game, has the ability to take photos, videos and update a mobile blog, which is available for other supporters via mobile phone, internet access.

Future Enhancements
Voice-guided prompting and training programs via mobile phone.
Member-to-member mobile chat and message boards.
Online and mobile shopping for supplements linked to diet plans.
Video viewing of training routines and enhancement exercises.
Automatic update of heart rate via watch heart rate monitor via mobile phone to the system.
Sport and fitness Mobile TV Channel.

It will be apparent that the invention can be adapted to advances in digital and information technology and these are included in the scope of the invention.

1. Apparatus which includes a central processing unit or computer which is programmed with the facility to store data, communicate through the internet to a mobile phone network and thence to mobile phones and/or mobile devices and personal computers (PC's), the data including measurable physical characteristics, performance characteristics, nutritional and other information of individuals stored as historical data and as variable goal setting options, programs for development and improvement of these characteristics, linked to gymnasium and sporting facility environments, access codes and routing protocols for messaging to and from a cell phone and/or mobile device and for transfer of data, date and time interface functionality and optionally diary and event data, the communication between these being two-way, the data that is sent to the database being converted into feedback that is displayed in graphic form for the user and the information used by the member displayed either on a cell phone or on a PC browser.

2. Apparatus as claimed in claim 1, which utilizes one selected from wireless application protocol (WAP), 3G, OPRS, HSDPC and future possible communication layers, short messaging service (SMS) and multi media service (MMS) technologies, so that the programmes may not be downloadable applications, but browser-based communications and dynamic data transfers may be used rather than SMS messages, which allows two-way continuous communication to and from a fitness gym or other locale about sporting events.

3. A method of physical training in a sport or in bodily development or fitness, which comprises the steps of registering personal particulars and goals on a database, receiving a training program designed to achieve the goals, carrying out the program and monitoring development towards the goal, modifying the program as the person progresses, providing feedback that has the effect of motivating the user to stick to the training routine as a consequence of measurable, quantifiable results, the system making visible the inputs as well as the outputs of the user thereby enhancing the training experience.

4. A method as claimed in claim 3, in which the member is able to access training and nutritional information on demand from a cell phone wherever there is the abitity to connect, including in a gym while actively engaged with exercises, the member being able to forward information from the locality where he or she is to the central database and software is adapted to generate a report that includes graphic representation of progress of the individual towards a goal, which is set by the individual and/or suggested by the system, competitive aspects handled by the system as well, including the comparative progress or position relative to other members that are using the system.

5. A method as claimed in claim 3 in which the database also contains and is regularly updated by a system operator with information about sporting and other events and a program is operated to send out notices (alerts) to members about upcoming events, giving dates, times and locales.

6. A method as caimed in claim 5, in which a ‘message box’ function is implemented and the data includes historical (including very recent) information about major competitive events, sent out as news items to member's cell phones, with features about players in professional sports, matches etc included.

7. A method as claimed in claim 3, in which a registration screen via internet or cell phone/mobile device allows registration and recording of personal details and a computer program provides a program of exercise and/or activity to lead the person to achieving specified goals.
